(19) United States
(12) Patent Application Publication
(10) Pub. No.: US 2005/0067485 A1
(43) Pub. Date: Mar. 31, 2005

(54) Apparatus and method of identifying the user thereof by means of a variable identification code

(76) Inventor: Michel Caron, St-Ferreol-les-Neiges (CA)

Correspondence Address: Michael Caron;Protections Equinox Int'l Inc, 4480 Cote-de-Liesse, Suite 224, Montreal, QC, H4N 2R1, CA

(21) Appl. No.: 10/500,797

(22) PCT Filed: Jan. 16, 2003
(86) PCT No.: PCT/CA03/00049

(30) Foreign Application Priority Data
Jan. 17, 2002 (CA) 2367309
Aug. 7, 2002 (CA) 2394742

(51) Int. Cl. G06K 5/00

(52) U.S. Cl. 235/380; 340/5.1; 705/65

(57) ABSTRACT

The invention relates to an apparatus (1) and a method (100) which form a universal identification means for a user party. The identification of the user can be made with respect to one of several second parties. The inventive apparatus consists of: a data input device (4, 5, 7, 8, 9, 11, 12, 13 and 15), a device for selecting the second party (4, 5, 7, 8, 9, 12, 13, 15) from a plurality of second parties in relation to which said user party can be identified, a data output device (2, 15) and a data processing device (14) comprising a storage device and an algorithm (60, 70) allowing to generate a variable identification code (10) which is specific to a given use by the user party and to disclose the code using the data output device (2, 15).

### FIELD OF THE INVENTION

The present invention relates to the sector of apparatuses and methods allowing a user party to formally become identified with a second party among a plurality of second parties. More specifically, the invention offers a universal process of identification and an electronic apparatus allowing a dedicated end-user to formally become identified with one out of many second parties.

### BACKGROUND OF THE INVENTION

Identity theft has long been a problem to society and while ID (IDentification) cards were created to alleviate this problem it had become obvious that they were somewhat less than perfect in protecting the end-user as evidenced by the massive increase in credit card theft and forgery that led to considerable losses for the international financial system. In order to be ahead of the fraudors, financial institutions responded to the problem by introducing the ATM (Automatic Teller Machine) or debit card which required the end-user to enter a Personal Identification Number (PIN) prior to any transaction. On the surface this appeared to be a brilliant solution but in time it became obvious that it had drawbacks as well and fraudors have found ways to get around it for a few years now. It is important for everyone's both physical and financial health to have recourse to more effective means to arrest this scourge. In addition, it has been recognized of the need of such an effective identification means not only to significantly reduce the amount of frauds related to debit and credit cards but also to allow other adherent organizations such as government agencies, employers, etc. to formally identify their end-users, clients or employees even though, and especially, if the latter are remotely located.

Existing patent applications (U.S. Pat. No. 5,317,636, WO9964956, U.S. Pat. No. 4,849,613, U.S. Pat. No. 5,130,519, U.S. Pat. No. 6,247,129, U.S. Pat. No. 6,163,771, U.S. Pat. No. 4,697,072, U.S. Pat. No. 5,311,594, U.S. Pat. No. 5,485,519) that were filed and/or issued for methods concerning the authentication of the client having a payment card in the context of commercial transactions. All these methods and apparatuses, although inventive, lack certain characteristics that would allow them to fill all their needs toward the identification of the card holder.

Apparatuses and methods known to date are made to identify the holder of a payment card but it is well known that it is often necessary for a person to become identified with many organizations in different situations than a commercial transaction using either a credit or a debit card.

Software already exists on the market for the supply of a unique number code during credit card Internet transactions or the accessing of high security databases. Also available on the market is a small portable apparatus, which constantly displays a different code on its screen at regular interval such as 30, 45 or 60 second intervals. This code is generated by means of an algorithm integrated into the microprocessor of the apparatus. A computer server having the same algorithm can verify the authenticity of the person by requiring submission of the code at any time during a communication. Most of the time the transmission of the code is made as connection to the server takes place. The drawback to this system is that apparatus is usable in relation with only one site and is not totally safe since the code is constantly visible on the screen and anyone carrying the apparatus could use it as if he is the legitimate holder.

Various innovations were proposed for the inclusion of a random number generator inside the credit card or ATM card itself but the problem of unauthorized visual access to the code as above described still remain; a person not being the card holder could make transactions with a stolen card since the code is usually transmitted via an electronic chip readable through a reader. Additionally, the installation cost of a system required for chip card readers to locations which would best serve the most end-users would appear to be prohibitively expensive. These methods are useless in world regions not having such readers. Furthermore, Internet transactions are impossible with such methods unless they are made using computers equipped with such chip card reader.

Yet another problem with the above-mentioned innovations is the introduction of the “time variable” in the algorithm which generates the unique code. For a transaction to be easy and rapid the transmission of the code must be made in real-time. As it is, communication of the details of commercial transactions are not done in real-time. This is particularly true for any payment card type transaction made abroad. There are also many proposed solutions that include details such as the total amount of the money transaction into the algorithm or encrypt the transaction number such that it could not be intercepted during the transmission. All this introduces delay of the treatment of the transaction: if the number sent for identification includes variables such as the actual time, the total amount, etc., the receiving financial institution needs to decode the number before authorizing the transaction. As the quantity of simultaneous transactions is usually large, only a few tenths of a second delay makes the treatment more complex and expensive than simply validating the current PIN.

The technologies taught in current patents also have the disadvantage of being usable with only one institution at a time. This inevitably significantly increases the cost of implementation of these processes.

In conclusion, the existing solutions contain several limitations, disadvantages and inconveniences which effectively prevent them from meeting the frequent needs of identification of each end-user, and the requirements from the adherent organizations. Notably, these solutions do not offer to simultaneously serve several organizations of different nature. Further than failing to make practical and market acceptable monetary transactions with credit cards safer, they prove themselves unable to allow identification of an end-user within several sectors of economic activities or lines of business.

### OBJECTS OF THE INVENTION

An object of the present invention is to provide a device and a method of identification that overcomes the limits and drawbacks mentioned above.

A second object of the present invention is that several institutions could use the same apparatus to significantly reduce the implementation costs associated therewith.

Another object of the present invention is that a same apparatus can provide all variable identification codes (VIC) for the user to become formally identified with several adherent organizations during transactions therewith.

Another object of the present invention is that the method does not require the installation of new terminals and functions with the already existing ones.

### SUMMARY OF THE INVENTION

According to a first aspect of the invention, there is provided an apparatus for providing a unique transaction number and different for each use from its holder, comprising a card having keys and a display; an electronic circuit integrated into the card; and a program embedded into the electronic circuit enabling reception of a code entered by the holder using the keys of the card and display the unique transaction number on the display.

It is to be noted that the apparatus can be a chip card that connects to a terminal which includes the necessary keys and display, the terminal being at the transaction or identification location.

According to a second aspect of the invention, a universal identification apparatus allowing a user party to formally become identified with a second party is proposed, said universal identification apparatus comprising: a) a data entry device; b) a selection device for selection of the second party among a plurality of second parties said user party can become identified with; c) a data output device, and; d) a data processing device comprising a memorization device and an algorithm, and allowing generate a variable identification code (VIC) specific to a given use by the user party and to reveal it by means of said data output device.

According to a third aspect of the invention, a universal identification method allowing a user party to formally become identified with a second party by means of an identification apparatus is proposed, said method comprising: a) to select a second party among a plurality of second parties recorded within the apparatus said user party may become identified with; b) to enter a data characteristic of the user party into the apparatus; c) to obtain a variable identification code (VIC) specific to the current use calculated by the apparatus; d) to communicate said variable identification code (VIC) to the second party; and e) to analyze said variable identification code communicated to the second party with the aim of verifying an identity of the user party.

According to a fourth aspect of the invention, a universal identification method allowing a user party to formally become identified with a second party by means of an identification apparatus is proposed, said method comprising: a) to open a file with said second party, including to record into said file a personal identification number (PIN) characteristic of the user party and to obtain from the second party at least one data characteristic of said second party; b) to record within said apparatus the PIN characteristic of the user party and at least one said data characteristic of the second party, recorded into said file; c) to use the apparatus to obtain a variable identification code (VIC) allowing the second party to verify the identity of the user party, including to select a second party among a plurality of potential second parties for which a file is opened and data characteristic thereof are recorded within the apparatus and to enter a PIN into the apparatus; and d) to communicate said variable identification code to the second party.

According to a fifth aspect of the invention, a universal identification method allowing a user party to formally become identified with a second party by means of an identification apparatus is proposed, said method comprising: a) to open a file with said second party, including to obtain at least one data characteristic of said second party; b) to record within said apparatus at least one said data characteristic of the second party, recorded into said file; c) to record within said apparatus a biometric data characteristic of the user party; d) to use the apparatus to obtain a variable identification code (VIC) allowing the second party to verify the identity of the user party, including to select a second party among a plurality of potential second parties for which a file is opened and data characteristic thereof are recorded within the apparatus and to enter a biometric data into the apparatus; and, e) to communicate said variable identification code (VIC) to the second party.

The proposed identification method relies on the supplying to a second party (further below called: adherent organization), of a variable identification code (VIC) of more or less five characters from the which is unique and different for each use thereof by the user or first party (further below called: holder) of the apparatus. As this VIC is valid for a single use only, any interception of this data is of no concern since a brand new VIC will be required for a further use to be validly carried out.

### BRIEF DESCRIPTION OF THE DRAWINGS

With regard to the drawings which illustrate the embodiment of the invention.

FIG. 1 represents the front view (in plan) of the apparatus (1) in accordance with the present invention;

FIG. 2 represents a front view of the apparatus (1) integrating a fingerprint reader (11), according to an alternate embodiment of the present invention;

FIG. 3 represents a front view of the apparatus (1) integrating keys (12) allowing for the selection of an adherent organization, according to an alternate embodiment of the present invention;

FIG. 4 represents a front view of the apparatus (1) integrating a numerical keypad (13) and keys (12) allowing for the selection of an adherent organization, according to an alternate embodiment of the present invention;

FIG. 5 represents a front view of the apparatus (1) integrating a transducer (15) serving as a microphone or speaker for the use of input and output of data, according to an alternate embodiment of the present invention.

FIG. 6 represents a functional diagram of the microprocessor (14) integrated into the apparatuses (1) of FIGS. 1, 3 and 4, according to an alternate embodiment of the present invention.

FIG. 7 represents a functional diagram of the microprocessor (14) integrated into the apparatuses (1) of FIGS. 2 and 5, according to an alternate embodiment of the present invention.

FIG. 8 represents a block diagram of the method used by the holder for the operation of the apparatuses (1) of FIGS. 1, 3 and 4, according to an alternate embodiment of the present invention.

FIG. 9 represents a block diagram of the method used by the holder for the operation of the apparatuses (1) FIGS. 2 and 5, according to an alternate embodiment of the present invention.

FIG. 10 represents a flow diagram of the general method used for all models (FIGS. 1, 2, 3, 4, and 5) of the apparatus (1) during the identification of the holder, according to an alternate embodiment of the present invention.

FIG. 11 represents a flow diagram of the operations of an identification process in accordance with an alternate embodiment of the present invention.

### DETAILED DESCRIPTION OF THE ILLUSTRATED EMBODIMENTS

The similar elements of the various figures of the attached illustrations are identified by the same reference numbers.

We are now going to describe in detail the preferred embodiments of the apparatus and the method of the present invention by referring to the annexed drawings.

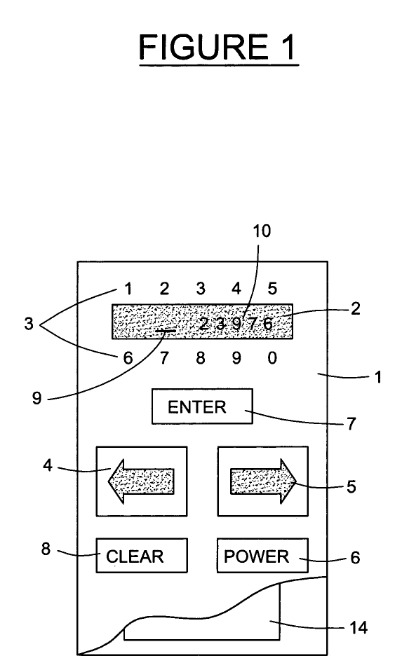

Referring to FIG. 1, we see that the apparatus (1) consists of a case (1) the size of a traditional ID card but slightly thicker which includes a microprocessor (14), an energy source which can be a battery or a solar energy collector. The case can be rectangular in shape as seen in FIG. 1 or have any other shape.

The case includes a display screen (2), figures (3) 1, 2, 3, 4, 5, 6, 7, 8, 9, 0 printed around the screen (2) and five keys (4, 5, 6, 7; 8) which are as follows: A key (6) bearing the inscription “power” being used to activate the apparatus (1); A key (7) bearing the inscription “enter” used for validation and the recording of data; A key (8) bearing the inscription “clear” used for the cancellation of the last validated data; A key (5) bearing an arrow icon used to move the cursor (9) to the right of the screen (2); A key (4) bearing an arrow icon used to move the cursor (9) to the left of the screen (2);

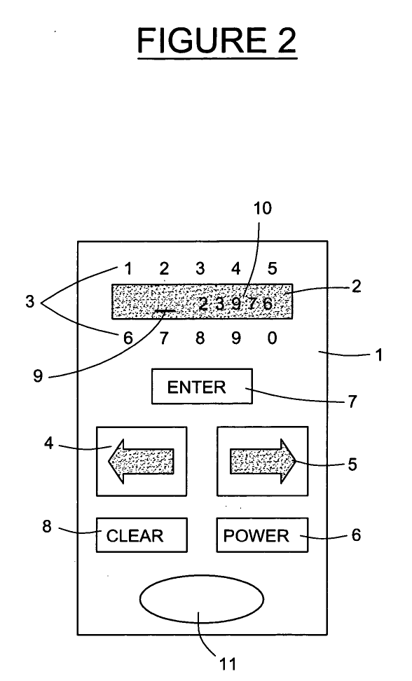

The drawing in FIG. 2 represents another model of the apparatus (1). In this model the identification of the holder is not made by entering a PIN but rather by the reading of a fingerprint. For that purpose a mini fingerprint reader (11) is integrated on the surface of the apparatus (1). The microprocessor (14) records the digitized fingerprint of its holder during the initial activation of the apparatus (1). Afterwards, the identification of the holder is made by comparing (72) the digitized fingerprint of the finger that is placed on the mini reader (11) to the one in the memory of the microprocessor (14) of the apparatus (1). If they are identical, then the apparatus displays (67, 75) the VIC (10) for the desired file.

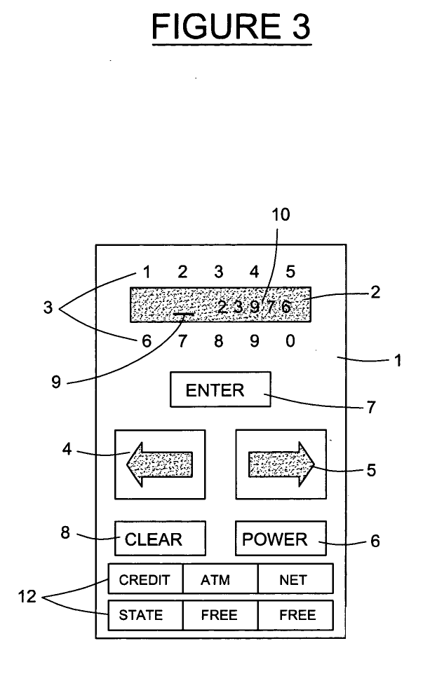

The drawing in FIG. 3 represents a model of the apparatus (1) which is comparable to that of FIG. 1. The difference being with the integration of a supplementary keypad (12) which allows to directly choose a file from among those which were activated beforehand by hitting on the appropriate key (12).

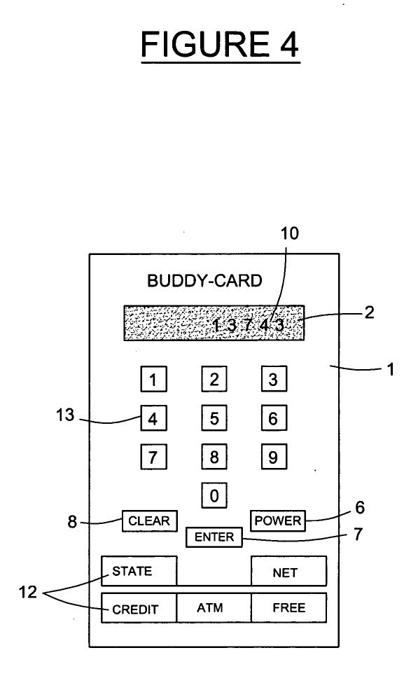

The drawing in FIG. 4 represents an apparatus (1) which does not contain a secured keypad (4, 5) but instead, a standard numerical keypad (13). This apparatus (1) is also provided with a keypad (12) allowing to directly choose the file from the ones which were activated beforehand by hitting the appropriate key (12).

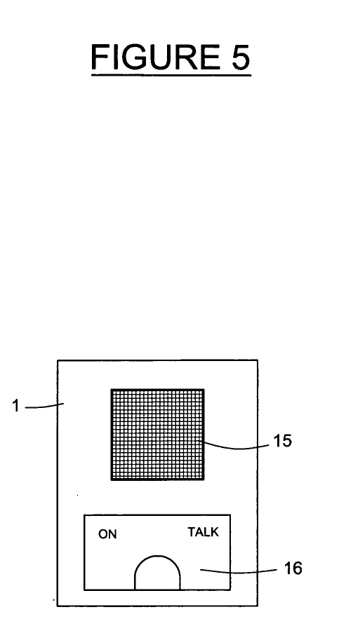

The drawing in FIG. 5 represents an apparatus (1) with a transducer (15) serving as a microphone or speaker, hence for the input and output of data. It is activated by hitting the key (16). The apparatus (1) will be in data input mode when the talk key (16) is pressed down, the input of data is made verbally by the user. The output of data is also made verbally via the speaker when the key (16) is not being pressed down.

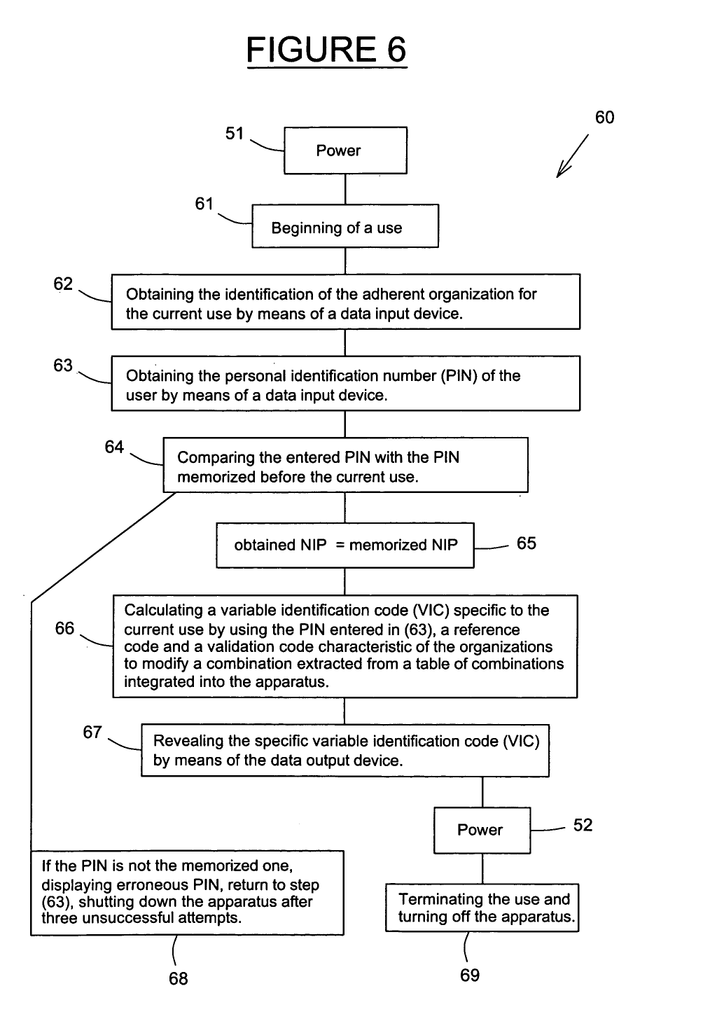

FIG. 6 represents a functional diagram of the apparatuses (1) working on the identification of the holder through the use of a PIN (FIGS. 1, 3, 4). The apparatus (1) is turned on by hitting (51) the “power” key (6) to begin a use (61). The holder chooses the adherent organization (62) then enters his PIN (63). The microprocessor (14) compares (64) the PIN entered with the PIN in the memory (14). If the PIN entered is different from the memorized PIN (68) then the apparatus (1) requests reentry (63) of the PIN. After three unsuccessful attempts, the apparatus (1) shuts down. In order to reactivate the apparatus (1) the holder has to enter a special code supplied by the adherent organization. If the entered PIN is identical (65) to the memorized PIN then the microprocessor (14) generates a variable identification code (VIC) (10) specific to the current use by using the entered PIN (63), a reference code (82) and a validation code (83) characteristic of the adherent organization to modify a combination extracted from a table of combinations integrated into the apparatus (1). The variable identification code (VIC) (10) is revealed (67) by means of the data output device (2). The end user hits (52) the “power” key (6) to terminate use and turn off (69) the apparatus (1).

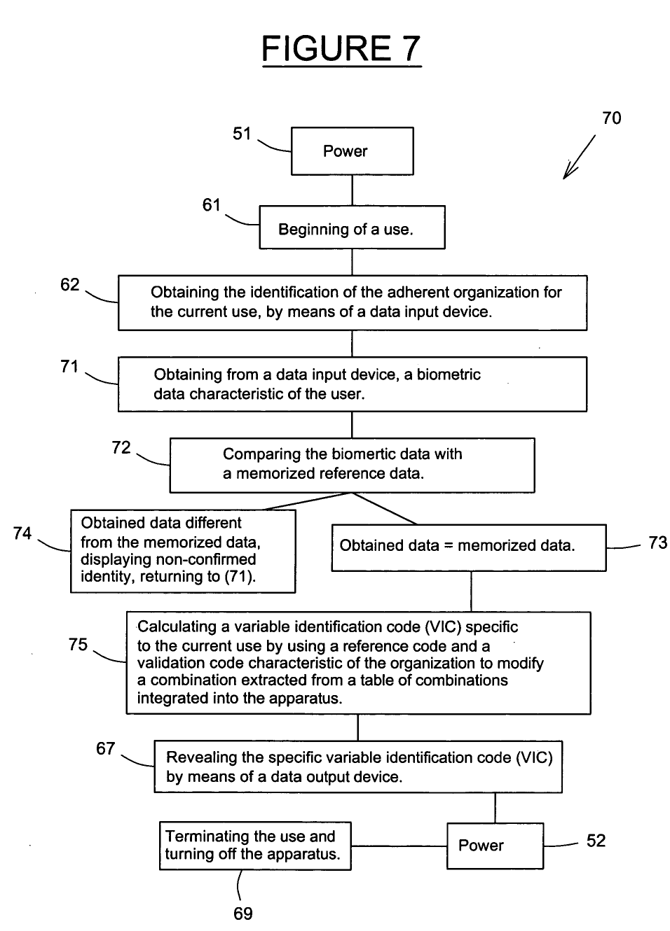

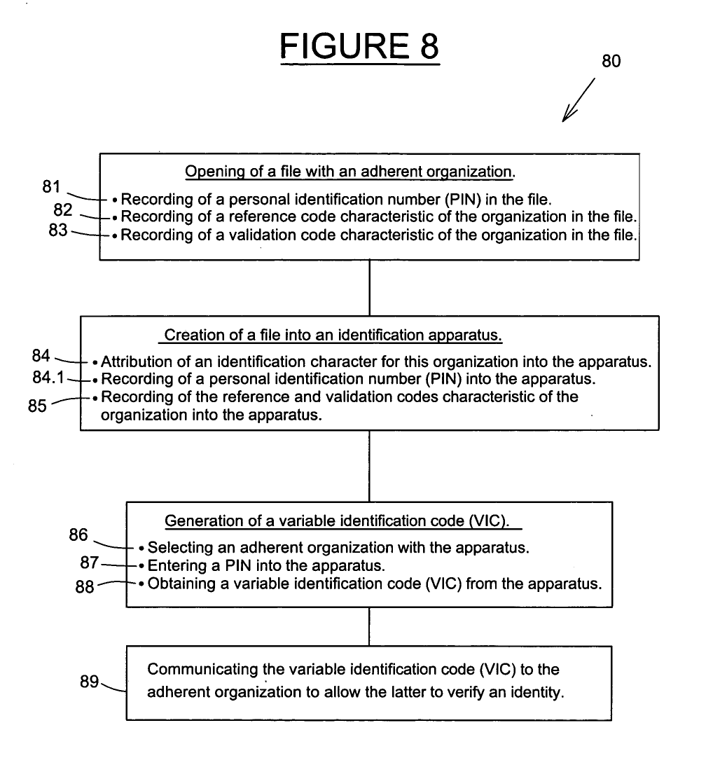

FIG. 7 represents a functional diagram of the apparatuses (1) working on the identification of the holder by the supply of biometric data (FIGS. 2 and 5). The apparatus (1) is turned on by hitting (51) the “power” key (6 or 16) to begin a use (61). The holder chooses the adherent organization (62) then provides a biometric data (71). The microprocessor (14) compares the data with the one in memory (14). If the entered biometric data (71) is different from that the memorized one (74) then the apparatus (1) requests reentry (71) of the biometric data. After three unsuccessful attempts, the apparatus (1) shuts down. In order to reactivate the apparatus (1) the holder has to enter a special code supplied by the adherent organization. If the entered biometric data is identical (73) to the memorized one, the microprocessor (14) then generates (75) a variable identification code (VIC)(10) specific to the current use by using a reference code (82) and a validation code (83) characteristic of the adherent organization to modify a combination extracted from a table of combinations integrated into the apparatus (1). The variable identification code (VIC) (10) is revealed (67) by means of the data output device (2, 15). The end user hits (52) the “power” key (6) to terminate the use and turn off (69) the apparatus (1). FIG. 8 represents a block diagram illustrating the steps needed to open a file (80) up to the transmission (89) of a variable identification code (VIC) (10) for apparatuses (1) (FIGS. 1, 3 and 4) identifying the holder by the supplying (63) of a PIN. To open a file with an adherent organization, the holder of the apparatus (1) registers (81) a personal identification number (PIN) with the organization. The organization issues a reference code (82) and a validation code (83) characteristic of this organization for this end-user. The holder of the apparatus (1) then activates a file in his apparatus (1) for this organization. He gives (84) it an identification character then records (84.1) his corresponding personal identification number (PIN). He records (85) in his apparatus (1) the reference code (82) and the validation code (83) characteristic of the organization. To obtain a variable identification code (VIC) (10) the holder must select (86) with his apparatus (1) an adherent organization, enter his PIN (87). In this way he obtains (88) from his apparatus (1) a variable identification code (VIC) (10). He then communicates (89) this variable identification code (VIC) (10) to the adherent organization to allow the latter to verify his identity.

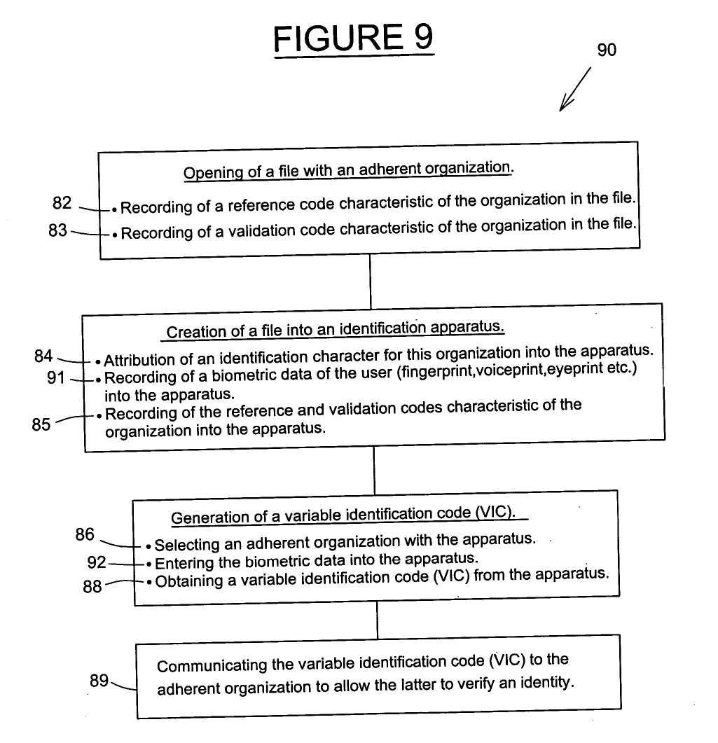

FIG. 9 represents a block diagram illustrating the steps needed to open a file (90) up to the transmission (89) of a variable identification code (VIC) (10) for apparatuses (1) (FIGS. 2 and 5) identifying the holder by the supplying (71) of biometric data. To open a file with an adherent organization, this organization issues a reference code (82) and a validation code (83) characteristic of this organization for this end-user. The holder activates a file in his apparatus (1) for this organization by giving (84) it an identification character. Then he records (91) a biometric data. Next, he records (85) the reference code (82) and the validation code (83) characteristic of this organization in his apparatus (1). In order to obtain a variable identification code (VIC)(10) the holder must, by means of his apparatus (1), select (86) an adherent organization, enter (92) a biometric data. In this way he obtains (88) from his apparatus (1) a variable identification code (VIC) (10). He then communicates (89) this variable identification code (VIC) (10) to the adherent organization to allow the latter to verify his identity.

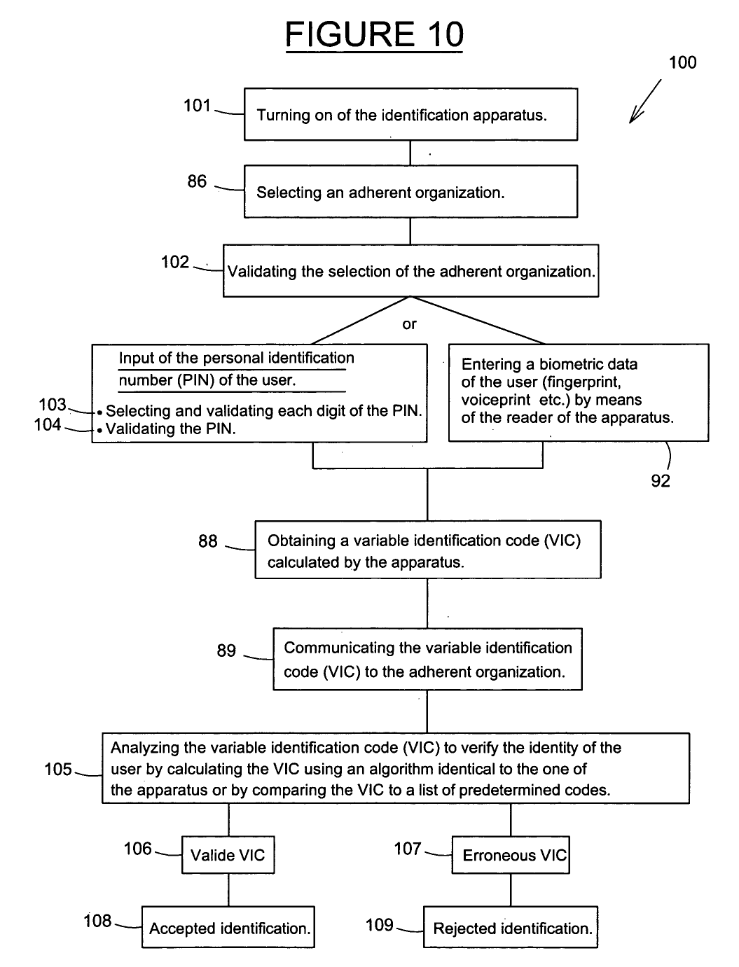

FIG. 10 represents a flow diagram of the general flow (100) of an identification process. The holder must first turn on (101) his apparatus (1), select (86) and validate (102) an adherent organization using the data input device (4, 5, 7, 8, 11, 12, 13, 15). According to the model of apparatus (1) he holds, he must (FIGS. 1, 3 and 4) enter (103) and validate (104) his PIN, or for the apparatuses of FIGS. 2 and 5 enter (92) a biometric data by means of the appropriate device (11 and 15). After validation (65 or 73), the apparatus (1) provides (88) a variable identification code (VIC) (10). The user communicates (89) this VIC (10) to the adherent organization. The latter analyzes (105) the VIC, if the provided (89) VIC (10) is valid (106) the identification of the holder by the adherent organization is then validated (108). If the transmitted (89) VIC (10) is erroneous (107) the adherent organization then rejects the identification of the holder.

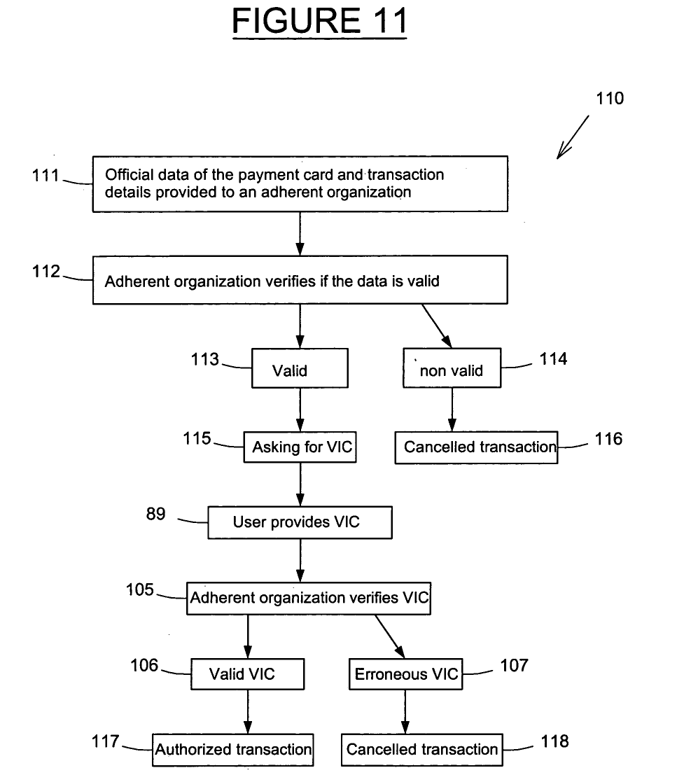

FIG. 11 is a simplified schematic demonstrating a procedure of authorization according to the present invention for a commercial transaction with a payment card. The holder of the apparatus (1) brings the intended purchase to the cashier. Having decided to pay the purchase price with his payment card, he offers it to the cashier. The cashier enters the necessary details into the cash register such as the purchase amount then swipes as usual the card through the magnetic card reader to establish the communication (111). The communication takes place with current protocols. The adherent organization verifies (112) the validity of this information and when validated (113) the transaction can continue, otherwise (114) the transaction is cancelled (116). Once this step is over, the financial institution that issued the payment card asks (115) the variable identification code (VIC) (10) from the holder. The holder, by means of his apparatus (1) gets (115) a variable identification code (VIC) (10) and transmits (89) this (VIC) (10) to the adherent organization which validates (105) it. If it is erroneous (107), the transaction is cancelled (118). If the transmitted (89) VIC (10) is valid (106) then the transaction is authorized.

The apparatus (1) and the method (100) are dedicated to the identification of its holder in the course of approaches undertaken with organizations that has adhered to this service. The identification is made by means of a code called “variable identification code (VIC (10)”. This code is unique and different for each use. It is valid for a single transaction then replaced by another VIC (10) for a subsequent use. The variable identification code (VIC) (10) is supplied by the apparatus (1) and revealed (67) to its holder by means of the data output device (2, 15). The same apparatus (1) serves to identify its holder in various situations of everyday life such as interactions with his employer, the government, transactions using a payment card (credit or debit) or transaction with any other adherent organization. Accordingly, the apparatus (1) processes several files that could be allocated (84) to different organizations by its holder.

The apparatus (1) has a data output device (2,15) and a data input device (4, 5, 7, 8, 9, 11, 12, 13, 15) offering its holder a completely safe use. To get a variable identification code(VIC) (10), the holder identifies himself by entering (103, 104) a personal identification number (PIN) or a biometric (FIGS. 2, 5) data (92) which can be a fingerprint, voiceprint, etc. according to the model being used.

The apparatus (1) works in cooperation with other ID cards of the holder such as social insurance, credit and ATM cards as well as driver license, passport, etc. Depending on the degree of security required by any given adherent organization, the variable identification code (VIC) (10) is requested either on a regular or occasional basis.

The apparatus (1) issues to its holder a different variable identification code (VIC) (10) for each use thereof regardless of the selected organization.

The variable identification code (VIC) (10) provided by the apparatus (1) is passed on (89) by the holder to the adherent organization manually by existing transmission technologies which serve PIN users such as retail terminals, ATMs and computer stations. This is the reason that made us to propose a VIC (10) of approximately five characters such that it has the format of PINs already in use.

The holder of the apparatus (1) identifies (92, 103, 104) himself in order to use his apparatus (1). Depending on which model (FIGS. 1, 2 and 5) of apparatus (1) is being used, this identification is made by entering a personal identification number (PIN) (103, 104) or by supplying a biometric data (92). In the case of the latter method, the holder records (91) the biometric data into the apparatus (1) at the first activation of the apparatus (1). This biometric data is stored in the memory of the microprocessor (14) of the apparatus (1). Only a positive match of actual biometric data to that which is in the memory of the microprocessor (14) will permit the issuing of a variable identification code(VIC) (10). This process precludes the danger of identity infringement by abuse of the privacy and security of the holder that could occur through the supplying to and the possession of biometric data by several organizations. With the proposed method (100), the biometric data is supplied and kept exclusively within the apparatus (1) of the holder; the transmission of a good variable identification code(VIC) (10) formally identifies the holder since it is required to supply the biometric data to obtain the good VIC (10). Other models (FIGS. 1, 3, 4) of the apparatus (1) require entry of a personal identification number (PIN) (87) into the apparatus (1) via the data input device (4, 5, 7, 8, 9, 13) for their use.

Another model (FIG. 4) has a standard numerical keypad (13) allowing the input of the PIN (87) and other numerical data. The models listed here are not restrictive.

The apparatus (1) works by means of a microprocessor (14) which acts as an administrator of files and issuer of VIC (10) by means of an algorithm. The role of the apparatus (1) is to provide for a different variable identification code (VIC) (10) for each request made by the card holder. From an algorithm common to all the apparatuses (1), the calculation (66, 75) to provide this unique VIC (10) is made by taking into account two numerical data (85) specific to each of the files and for each of the card holders: a reference code (82) and a validation code (83). Each of these codes (82, 83) is supplied by the adherent organization. A third data, being the PIN, chosen by the holder and registered (81) with the adherent organization also has a role to play within the algorithm for the supplying of the good VIC (10). For models (FIGS. 2 and 5) working with a biometric data, the algorithm takes into account only both specific numerical data (82, 83) supplied by the adherent organization to generate the variable identification codes(VIC) (10).

According to the preferred method, there is provided the general functioning of the algorithm, there exists in all apparatuses a basic table consisting of 10 rows. Each of these rows consists of a 12-figure code. This basic table is present 5 times in apparatuses able to handle 5 files and 15 times for apparatuses able to handle 15 files etc. Each of the files works independently of the other files.

According to the preferred method, the adherent organization supplies a reference code, which also is a 12-figure code. It also supplies a 2-figure validation code. The holder of the apparatus (1) records these two data into his apparatus (1) by means of the data input device. Once this information is recorded, the algorithm completes the following operations: Independently, each one of the 10 rows of the basic table containing a 12-digit code will add up to the 12-digit reference code supplied by the adherent organization. This operation is repeated a number of times equals to the value of the validation code. If the validation code is 14, then each of the 10 12-digit codes of the basic table adds up 14 times to the reference code. After each of these additions, if the result is a 13-digit number, the first digit that is always “1” is eliminated to keep only the last 12 digits. The goal of this operation is to completely modify the basic table, which becomes a modified table, the latter being used to generate the variable identification codes(VIC) (10). An apparatus (1) having 11 active files has after this operation 11 completely different tables for the selection of the variable identification codes(VIC) (10) of each of the files.

From this point, the way to choose the figures that make the VIC (10) is identical for each file and for each apparatus. The only exception is for the apparatuses (1) functioning with a PIN for the identification of its card holder. For these apparatuses, an additional mathematical operation is made using the PIN to modify the variable identification code (10). This is this modified VIC (10) that is revealed through the data output device.

According to the privileged method, the selection of the first VIC (10) for a specific file uses the first row of the modified table. The second selection uses the second row, etc. up to the tenth selection that uses the tenth row. For the eleventh selection we come back to the first row, but just before the selection occurs, the modified table is modified again. As for the first modification, the 12-digit codes contained within the 10 rows are added again to the reference code that is also a 12-digit number. This way, each row of a modified table is used only once for the selection of a variable identification code (VIC) (10) and is modified again prior to its subsequent use.

Alternate embodiments of the algorithm could include “time” variable elements generated by an electronic clock device integrated with the microprocessor (14). These “time” variable elements could be either the time and/or the date. Other variable elements could be added such as the total amount of a purchase or a geographical situation without the scope of this invention.

The adherent organizations having in their own computer system the same algorithm and knowing the three specific data as detailed in the present description, could generate the VIC (10) of each of their clients and authorize (108) the transaction after having validated (106) the variable identification code (VIC) (10) supplied (88) by the apparatus (1) of their client and transmitted (89) by him to them. Accordingly, they perform the same calculation (105) than that performed by the apparatus (1) for the client. The adherent organization, in order not to increase the processing time, could even generate (105) a certain number of variable identification codes (VIC) (10) in advance. The adherent organization knowing the clients holding apparatuses (1) functioning with biometric data (FIGS. 2, 5) takes only into account, for these clients only, the two specific numerical data (82, 83) that they transmitted themselves to the clients for the generation of the corresponding VICs (10).

According to the preferred embodiment, the adherent organization can, based on the desired level of security, work with a series of any number of waiting variable identification codes (VIC) (10) generated in advance. A financial institution could have a 10-VIC waiting list for each of their clients. This allows the organization to validate a VIC (10) that is not necessarily the next one on the list to be normally provided. This could happen, among others, when a client asks for a VIC (10) before settling a transaction and decides at the last moment not make the transaction. Hence this VIC (10) never gets to the financial institution and, when the same client makes a subsequent transaction with the payment card, his apparatus (1) provides him with a different VIC (10) and transmit the same to his financial institution. The financial institution that receives the second VIC (10) may authorize this transaction since they have the next 10 VICs (10) of their client in memory. According to its internal rules, the organization may decide to eliminate the first VIC (10) on its waiting list or to keep it for a certain period of time to make sure that this VIC (10) had not been used for a transaction the organization had not been notified of in real time. This way of working out things gives only 10 possibilities out of 10,000 to find the good VIC (10).

On the other hand, an employer such an administrator of an international airport that controls the access to high security rooms may decide to accept only the next VIC (10) of its employee. If the latter transmits a VIC (10) other than the next one on the list will have his security access to the desired room blocked. To get his security access reset he needs to get in touch with his employer to prove his identity. Each adherent organization may therefore adapt this system to its own needs.

The consumer manually transmits(89) this VIC (10) using the keypads already present at many locations, such as terminals at retailers, ATMs, telephones with keypads and the numerous computer stations available in our day-to-day life.

Since the VIC (10) is manually transmitted, this new method is suitable to conventional transactions using credit or debit cards with no need of implementing new generation terminals as well as to transactions made over Internet and the ones made over the phone. As seen above, this method can be used for transactions made with a government organization, an employer as well as with Internet websites to get access to secured pages, etc. How does the secured keypad (4, 5, 6, 7, 8) (FIGS. 1, 2 et 3). As opposed to the existing approaches, the keypad (4, 5, 6, 7, 8) used to record (84.1, 85) the essential data (reference code (82), validation code (83) provided by the adherent organization, PIN etc.) inside the apparatus (1) is not numerical. This secured keypad (4, 5, 6, 7, 8) is another innovation of this apparatus (1). It includes mainly two keys identified by arrows (4, 5). These keys (arrows) (4, 5) are used to scroll a cursor (9) appearing on the screen (2) of the apparatus (1). A key (arrow)(4) for displacing the cursor (9) to the left and another key (arrow) (5) for displacing it to the right.

Obviously, there are other keys on the apparatus (1). These other keys are respectively: “power”(6) to activate of the apparatus (1), “ENTER”(7) to validate and record an entry and “CLEAR”(8) to cancel the last entry. Lets look at how the keys (4, 5) of the apparatus (1) make the transaction much safer.

A user has already activated a file in his apparatus (1). He is with a retailer and wants to carry out a transaction. He turns on the apparatus (1) by hitting (51) the “power”(6) key. Then the inscription “file No.” appears on the screen (2) with a cursor (9) under the character (3) 1. Since the user has only one activated file (adherent organization) in his apparatus (1), he immediately presses down the “ENTER”(7) key to confirm that he wants to get a variable identification code (VIC) (10) for the file No. 1. Then the inscription “PIN” and a cursor (9) appear on the screen (2) of the apparatus (1). This cursor (9) is located under or above one of the characters (3) printed around the screen (2): “1 2 3 4 5 6 7 8 9 0”(3). For maximum security the cursor(9) never appears under or above the same character (3). It may appear under the character 1 and the next time reappear, in a random fashion, under the character 5 or above the character 8 etc.

For the purpose of our example, the PIN of the user is 6384. The cursor (9) appeared under the character (3) 2. Since the first digit of the PIN is 6, the user hits four times the right arrow(5) to move the cursor (9) above the character (3) 6. Then he hits the “ENTER”(7) key to validate and record this first digit.

The cursor (9) momentarily disappears from the screen (2) and reappears under or above another character (3), this character (3) being randomly selected again. At the same time, a symbol such as this one: “*” appears on the screen (2) to indicate that the first digit of the PIN has been selected. Obviously this symbol “*” will appear twice to indicate that the first two digits of the PIN have been selected, and so on. Resuming to our example, this time the cursor(9) reappears above the character 9. The user then hits six times on the left arrow (4) to move the cursor(9) under the character(3) 3. Since the second digit of his PIN is really the 3, he hits the “ENTER”(7) key to validate and record this digit. The same process starts over for the selection of the third and fourth digits of his PIN. In the case he would have made an error by hitting the “ENTER”(7) key too rapidly, he could have hit the “CLEAR”(8) key to cancel the last entry, make the correction and resume. The cursor is located at the top of the screen(2) for the characters (3) 1, 2, 3, 4, 5 and at the bottom of the screen (2) for the characters (3) 6, 7, 8, 9, 0.

With this new way of operating, a fraudor, even being on the lookout for it, and located nearby the user cannot see the user hitting the keys to enter his PIN. All the fraudor can see is the user hitting on the arrows (4, 5) to move a cursor (9) that never reappears under or above the same character (3) to start a new selection, hence a transaction with increased security.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

1-34. (canceled).

35. A universal identification device for providing a user first party with a variable identification code required for a transaction with a predetermined service provider second party to be validated, said device comprising:
a second party selection unit for selecting said predetermined second party from a plurality of second parties;
a data input unit for receiving a user identification code from said first party;
a data processing unit connected to said second party selection unit and said data input unit, said data processing unit processing said user identification code and said predetermined second party to generate said variable identification code required for said transaction to be validated; and
a data output unit connected to said data processing unit for receiving said variable identification code therefrom, said data output unit providing said variable identification code to said first party.

36. The device of claim 35, wherein said data processing unit includes a memory member having at least one second party key code corresponding to said predetermined second party stored therein, said data processing unit processing said user identification code and said at least one second party key code to generate said variable identification code required for said transaction to be validated.

37. The device of claim 36, wherein said data processing unit processes said user identification code and said at least one second party key code through an algorithm to generate said variable identification code required for said transaction to be validated.

38. The device of claim 37, wherein said second party selection unit includes a selection keypad, said selection keypad having a plurality of party keys, each of said plurality of party keys being assigned to a respective said plurality of second parties.

39. The device of claim 36, including a keypad, said keypad being connected to at least one of said second party selection unit and said data input unit.

40. The device of claim 39, wherein said keypad includes at least one selection key, at least one validation key and at least one deletion key.

41. The device of claim 40, wherein said data output unit includes a visual display.

42. The device of claim 41, wherein said visual display is connected to said second party selection unit, said at least one selection key allowing said visual display to successively display said plurality of second parties, said at least one validation key allowing selection of said second party being displayed.

43. The device of claim 41, wherein said visual display is connected to said keypad so as to allow said first party to enter a sequence of selected characters via said at least one selection key and without using character-identified keys, said visual display preventing display of said sequence of selected characters.

44. The device of claim 41, wherein said visual display includes a plurality of printed characters thereon and a displaceable cursor to successively face said plurality of printed characters, said visual display being connected to said keypad for cooperation therewith.

45. The device of claim 44, wherein said at least one selection key is a selection scrolling key, said selection scrolling key displacing said cursor for selection of successive figures corresponding to respective said plurality of printed characters, each said successive figures being selected by said user party using said at least one validation key when said cursor successively faces respective said plurality of printed characters, said successive figures forming data to be entered within said device.

46. The device of claim 45, wherein said cursor is randomly positioned after selection of respective said plurality of printed characters using said at least one validation key.

47. The device of claim 36, wherein said data input unit includes a microphone.

48. The device of claim 47, wherein said microphone is connected to said data output unit so as to be usable as a speaker when connected thereto.

49. The device of claim 47, wherein said microphone is connected to said second party selection unit so as to allow said first party to verbally select said predetermined second party from said plurality of second parties.

50. The device of claim 36, wherein said data input unit includes a biometric data reader.

51. The device of claim 50, wherein said biometric data reader includes a fingerprint reader.

52. The device of claim 50, wherein said biometric data reader includes a microphone so as to allow voice recognition for voiceprint input.

53. The device of claim 36, wherein said memory member has first and second second party key codes corresponding to each of said plurality of second parties stored therein, said data processing unit processing said user identification code and said first and second second party key codes corresponding to said predetermined second party to generate said variable identification code required for said transaction to be validated.

54. The device of claim 53, wherein said first and second second party key codes are stored in said memory member by said first party at registration of corresponding said plurality of second parties.

55. The device of claim 37, wherein said memory member includes a reference user code stored therein, said algorithm including:
a) obtaining data of said predetermined second party from said second party selection unit;
b) obtaining data of said user identification code from said data input unit;
c) comparing said user identification code with said reference user code, returning to step b) when said user identification code is different than said reference user code, and resuming when said user identification code is identical to said reference user code;
d) calculating said variable identification code using at least said at least one second party key code; and
e) providing said variable identification code to said data output unit.

56. The device of claim 55, wherein said memory member includes a predetermined combination table data stored therein, said algorithm calculating said variable identification code using at least said at least one second party key code to modify one of a successive combination of said predetermined combination table data.

57. The device of claim 55, wherein said memory member includes a predetermined combination table data stored therein, said algorithm calculating said variable identification code using said at least one second party key code and at least part of said user identification code to modify one of a successive combination of said predetermined combination table data.

58. The device of claim 55, wherein said algorithm turns said device off after a predetermined amount of successive returning to said step b) when successive said user identification codes are different from said reference user code.

59. The device of claim 35, wherein said data output unit is connectable to a terminal so as to communicate said variable identification code thereto.

60. The device of claim 59, wherein said device is a chip card having a chip therein connectable to the terminal, said data output unit connecting to said chip for communication of said variable identification code to the terminal.

61. A method for providing a user first party with a variable identification code using a universal identification device, said variable identification code being required for a transaction with a predetermined service provider second party to be validated, said method comprising:
a) selecting said predetermined second party from a plurality of second parties registered within said device;
b) receiving a user identification code from said first party;
c) processing said user identification code and said predetermined second party to generate said variable identification code required for said transaction to be validated; and
d) providing said variable identification code to said first party.

62. The method of claim 61, wherein said device includes at least one second party key code corresponding to said predetermined second party stored therein, said processing step c) including processing said user identification code and said at least one second party key code to generate said variable identification code required for said transaction to be validated.

63. The method of claim 62, wherein said device includes a reference user code stored therein, said processing step c) including:
c1) comparing said user identification code with said reference user code;
c2) returning to said receiving step b) when said user identification code is different than said reference user code;
c3) generating said variable identification code required for said transaction to be validated when said user identification code is identical to said reference user code.

64. The method of claim 63, wherein said device is turned off after a predetermined amount of successive returning to said receiving step b) when successive said user identification codes are different from said reference user code.

65. The method of claim 63, wherein said reference user code is a biometric data of said first party.

66. The method of claim 63, wherein said reference user code is known to said device only so as to remain confidential thereto without being communicated to said plurality of second parties or to a third party.

67. The method of claim 62, wherein said method further includes, before said selecting step a), the step of:
registering said plurality of second parties within said device.

68. The method of claim 67, wherein said registering step includes:
storing at least one second party key code for respective each said plurality of second parties within said device.

69. The method of claim 68, wherein said processing step c) includes:
processing said user identification code and said at least one second party key code through an algorithm to generate said variable identification code required for said transaction to be validated.

70. The method of claim 69, wherein said storing step includes:
storing two second party key codes for respective each said plurality of second parties within said device.

71. The method of claim 69, wherein said device includes a reference user code stored therein, said algorithm including:
c1) obtaining data of said predetermined second party and said user identification code;
c2) comparing said user identification code with said reference user code, returning to said receiving step b) when said user identification code is different than said reference user code, and resuming when said user identification code is identical to said reference user code; and
c3) calculating said variable identification code using at least said at least one second party key code.

72. The method of claim 71, wherein said device includes a predetermined combination table data stored therein, said algorithm calculating said variable identification code using at least said at least one second party key code to modify one of a successive combination of said predetermined combination table data.

73. The method of claim 71, wherein said device includes a predetermined combination table data stored therein, said algorithm calculating said variable identification code using said at least one second party key code and at least part of said user identification code to modify one of a successive combination of said predetermined combination table data.

74. The method of claim 61, further including:
e) communicating said variable identification code to said predetermined second party;
f) analyzing said communicated variable identification code to verify identity of said first party so as to validate the transaction.

75. The method of claim 74, wherein said analyzing step f) includes comparing said communicated variable identification code to a list of predetermined codes.

76. The method of claim 74, wherein said device includes at least one second party key code corresponding to said predetermined second party stored therein, said processing step c) including processing said user identification code and said at least one second party key code to generate said variable identification code, and said analyzing step f) including calculating at least one identification code through an algorithm using at least part of said user identification code and said at least one second party key code.
